(19) United States
(12) Patent Application Publication
(10) Pub. No.: US 2026/0066535 A1
(43) Pub. Date: Mar. 5, 2026

(54) HIGH-FREQUENCY CIRCUIT AND ANTENNA MODULE

(71) Applicant: Fujikura Ltd., Tokyo (JP)

(72) Inventor: Naoki Takayama, Sakura-shi (JP)

(73) Assignee: Fujikura Ltd., Tokyo (JP)

(21) Appl. No.: 19/312,871

(22) Filed: Aug. 28, 2025

(30) Foreign Application Priority Data
Sep. 2, 2024 (JP) 2024-150569

(51) Int. Cl. H01Q 3/34; H04B 7/0426

(52) U.S. Cl. CPC H01Q 3/34; H04B 7/043

(57) ABSTRACT

A high-frequency circuit includes a plurality of beam former ICs. The beam former IC includes a parameter acquisition unit and a set value acquisition unit. The parameter acquisition unit acquires a phase shift parameter related to phase shift of each of a plurality of antenna elements set corresponding to a direction of a beam-shaped high-frequency signal transmitted and received by each of the antenna elements. The phase shift parameter is acquired based on at least one phase gradient parameter related to a phase difference between the antenna elements adjacent to each other, a physical position of each of the plurality of antenna elements, and a density parameter related to resolution of a beam direction of the high-frequency signal. The set value acquisition unit acquires at least a set value of the phase shift of each of the antenna elements according to the phase shift parameter.

### BACKGROUND OF THE INVENTION

### Field of the Invention

The present disclosure relates to a high-frequency circuit and an antenna module.

Priority is claimed on Japanese Patent Application No. 2024-150569, filed on Sep. 2, 2024, the content of which is incorporated herein by reference.

### Description of Related Art

In the related art, for example, an integrated circuit that calculates a phase shift parameter corresponding to a desired beam pattern (antenna directivity) of a phased array antenna is known (see, for example, United States Patent Application, Publication No. 2023/0075523).

This integrated circuit calculates a phase shift parameter corresponding to the combination of a phase and an intensity to be set for each antenna element based on a position of each antenna element and a phase difference between adjacent antenna elements.

Incidentally, in the technology related to control of the beam pattern (antenna directivity) of the phased array antenna, it is desired to improve resolution of a beam direction. For example, in the above-described integrated circuit in the related art, a spacing between the beam directions may be fixed depending on physical design conditions such as an arrangement interval between a plurality of antenna elements, which may make it difficult to precisely control the beam direction.

An object of the present disclosure is to provide a high-frequency circuit and an antenna module capable of easily improving resolution of a beam direction in controlling a beam pattern (antenna directivity).

### SUMMARY OF THE INVENTION

In order to solve the above problem and obtain the above object, the present disclosure adopts the following aspects.

A high-frequency circuit (3) according to a first aspect of the present disclosure includes: a parameter acquisition unit (38) configured to acquire a phase shift parameter related to phase shift of each of a plurality of antenna elements (5) based on at least one phase gradient parameter related to a phase difference between the antenna elements adjacent to each other, the phase gradient parameter being set corresponding to a beam direction of a beam-shaped high-frequency signal to be transmitted and received by each of the plurality of antenna elements, a physical position of each of the plurality of antenna elements, and a density parameter related to resolution of the beam direction; and a set value acquisition unit (39) configured to acquire a set value of the phase shift of each of the antenna elements according to the phase shift parameter.

The high-frequency circuit according to a second aspect of the present disclosure is that in the high-frequency circuit of the first aspect, the parameter acquisition unit is configured to acquire the phase shift parameter based on at least one changed phase gradient parameter and a changed position obtained by the density parameter that acts in a canceling manner between the phase gradient parameter and the position.

The high-frequency circuit according to a third aspect of the present disclosure is that in the high-frequency circuit of the second aspect, the parameter acquisition unit is configured to store, in advance, data of the changed position according to the density parameter.

The high-frequency circuit according to a fourth aspect of the present disclosure is that in the high-frequency circuit of the second aspect, the parameter acquisition unit is configured to calculate the changed position based on the density parameter externally acquired and the position stored in advance.

The high-frequency circuit according to a fifth aspect of the present disclosure is that in the high-frequency circuit of any one of the first to fourth aspects, the parameter acquisition unit is configured to acquire the phase shift parameter based on a plurality of the density parameters independently set for a plurality of the phase gradient parameters.

The high-frequency circuit according to a sixth aspect of the present disclosure is that in the high-frequency circuit of any one of the first to fifth aspects, the set value acquisition unit is configured to acquire the set value of the phase shift of each of the antenna elements and a set value of intensity of each of the antenna elements according to the phase shift parameter.

The high-frequency circuit according to a seventh aspect of the present disclosure is that in the high-frequency circuit according to any one of the first to sixth aspects, the parameter acquisition unit is configured to represent a changed phase gradient parameter obtained by the phase gradient parameter and the density parameter in a two's complement fixed-point format.

The high-frequency circuit according to an eighth aspect of the present disclosure is that in the high-frequency circuit of any one of the first to seventh aspects, the parameter acquisition unit is configured to represent a changed position obtained by the position and the density parameter in a two's complement fixed-point format.

The high-frequency circuit according to a ninth aspect of the present disclosure is that in the high-frequency circuit of any one of the first to eighth aspects, the parameter acquisition unit is configured to execute acquisition of the phase shift parameter in parallel.

An antenna module according to a tenth aspect of the present disclosure includes: the high-frequency circuit (3) of any one of the first to ninth aspects; and a plurality of antenna elements (5) electrically connected to the high-frequency circuit.

According to the first aspect, it is possible to easily control the resolution of the beam direction by using the density parameter. For example, it is possible to change the resolution of the beam direction regardless of the radio frequency of a carrier wave, the arrangement state of the antenna elements, and the like. By increasing the resolution of the beam direction, it is possible to easily suppress deviations in a beam arrival position in long-distance communication or the like. Even in a case where the resolution of the beam direction fluctuates in accordance with a change in the radio frequency of the carrier wave, it is possible to perform appropriate measures such as cancellation by using the density parameter.

In the case of the second aspect, since the density parameter acts in a canceling manner between the phase gradient parameter and the position, it is possible to acquire the phase shift parameter based on the changed phase gradient parameter and the changed position through the same processing as in a case where the density parameter is not used.

In the case of the third aspect, since the data of the changed position corresponding to the density parameter is stored in advance, it is possible to suppress an increase in a load required for acquisition processing of the phase shift parameter. It is possible to improve the degree of freedom in controlling the beam pattern (antenna directivity) while suppressing a decrease in processing speed or an increase in the scale of the configuration required for processing.

In the case of the fourth aspect, since the changed position is calculated by the density parameter externally acquired, it is possible to flexibly respond to the change in the density parameter while suppressing an increase in the amount of data stored in advance.

In the case of the fifth aspect, it is possible to improve the degree of freedom in controlling the beam pattern (antenna directivity) by using the plurality of density parameters that are independently set for the plurality of phase gradient parameters without being restricted by the arrangement state and the like of the plurality of antenna elements.

In the case of the sixth aspect, by setting the intensity in addition to the phase shift of each of the antenna elements, it is possible to improve the degree of freedom in controlling the beam pattern (antenna directivity).

In the case of the seventh or eighth aspect, by using, for example, the two's complement fixed-point format that includes values with zero fractional digits, it is possible to suppress an increase in circuit size and the number of calculation processing steps. It is possible to decrease the time required for switching the beam pattern while suppressing an increase in cost required for the circuit configuration.

In the case of the ninth aspect, it is possible to decrease the time required for switching the beam pattern by the parallel processing.

According to the tenth aspect, it is possible to easily control, by using the density parameter, the resolution of the beam direction of the beam-shaped high-frequency signal emitted or received by each of the plurality of antenna elements.

### BRIEF DESCRIPTION OF THE DRAWINGS

FIG. 1 is a block diagram showing a functional configuration of an antenna module and a high-frequency circuit of an embodiment of the present disclosure.

FIG. 2 is a block diagram showing a functional configuration of a beam former integrated circuit of the embodiment of the present disclosure.

FIG. 3 is a diagram showing an example of X coordinates and Y coordinates of an array antenna in the embodiment of the present disclosure and a comparative example.

FIG. 4 is a diagram showing an example of a change in radiated power according to an angle of the array antenna in the embodiment of the present disclosure and the comparative example.

FIG. 5 is a diagram showing an example of an actual measurement value and a calculated value of a change in radiated power according to an angle of the array antenna when a changed phase gradient parameter of the embodiment of the present disclosure and a phase gradient parameter of the comparative example are set to a first predetermined value (=61).

FIG. 6 is a diagram showing an example of an actual measurement value and a calculated value of a change in radiated power according to an angle of the array antenna when the changed phase gradient parameter of the embodiment of the present disclosure and the phase gradient parameter of the comparative example are set to a second predetermined value (=122).

FIG. 7 is a diagram showing an example of an actual measurement value and a calculated value of a change in radiated power according to an angle of the array antenna when the changed phase gradient parameter of the embodiment of the present disclosure and the phase gradient parameter of the comparative example are set to a third predetermined value (=127).

FIG. 8 is a diagram showing an example of an actual measurement value and a calculated value of a change in radiated power according to an angle of the array antenna when the changed phase gradient parameter of the embodiment of the present disclosure and the phase gradient parameter of the comparative example are set to a fourth predetermined value (=−128).

### DETAILED DESCRIPTION OF THE INVENTION

Hereinafter, a high-frequency circuit and an antenna module according to an embodiment of the present disclosure will be described with reference to the accompanying drawings.

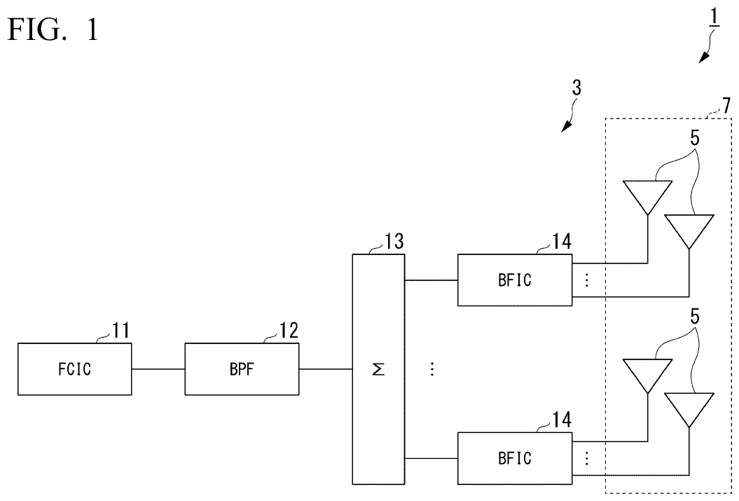

FIG. 1 is a block diagram showing a functional configuration of an antenna module 1 and a high-frequency circuit 3 of the embodiment. The antenna module 1 of the embodiment is provided in, for example, a wireless communication apparatus that performs beam forming for changing a beam pattern (antenna directivity) in a millimeter wave band. The antenna module 1 includes, for example, a plurality of integrated circuits (ICs) mounted on a first surface and an antenna mounted on a second surface, and the first surface and the second surface are both surfaces of a substrate such as a printed substrate in the thickness direction thereof.

As shown in FIG. 1, the antenna module 1 of the embodiment includes, for example, the high-frequency circuit 3 and an array antenna 7 formed of a plurality of antenna elements 5. The array antenna 7 is, for example, a so-called phased array antenna including the plurality of antenna elements 5 that are regularly arranged.

The high-frequency circuit 3 is, for example, an RF module including a so-called radio frequency IC (RFIC). The high-frequency circuit 3 includes, for example, a frequency converter IC (FCIC) 11, a band pass filter (BPF) 12, a divider/combiner (Σ) 13, and a plurality of beam former ICs (BFICs) 14.

The frequency converter IC (FCIC) 11 includes, for example, a local oscillator (LO) and a mixer. The frequency converter IC (FCIC) 11 converts a frequency between an RF signal transmitted and received by the array antenna 7 and an intermediate frequency (IF) signal by using, for example, an LO signal generated from the local oscillator.

The band pass filter (BPF) 12 passes, for example, a desired frequency band of the RF signal transmitted and received by the array antenna 7, and blocks a signal other than the desired frequency band.

The divider/combiner (Σ) 13 functions as, for example, each of a divider that divides a high-frequency signal and a combiner that combines high-frequency signals. The divider/combiner (Σ) 13 divides, for example, the RF signal output from the band pass filter (BPF) 12 among the plurality of beam former ICs (BFICs) 14. The divider/combiner (Σ) 13 combines, for example, the RF signals output from the plurality of beam former ICs (BFICs) 14 and outputs the combined RF signal to the band pass filter (BPF) 12.

Each of the plurality of beam former ICs (BFICs) 14 controls, for example, the beam pattern (antenna directivity) of the plurality of antenna elements 5.

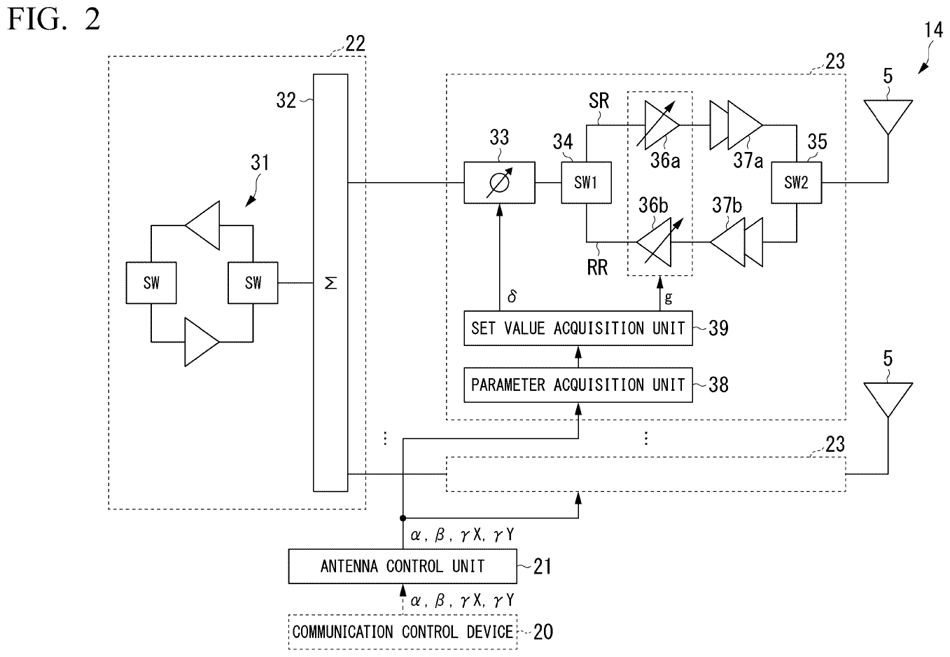

FIG. 2 is a block diagram showing a functional configuration of the beam former IC (BFIC) 14 of the embodiment.

As shown in FIG. 2, the beam former IC (BFIC) 14 is controlled by, for example, an external communication control device 20. The beam former IC (BFIC) 14 includes, for example, an antenna control unit 21, a relay circuit 22, and a plurality of front-end circuits 23.

The antenna control unit 21 controls, for example, the operation of the beam former IC (BFIC) 14 in accordance with information input from the external communication control device 20 or the like. For example, the information input to the antenna control unit 21 from an external source includes at least a first phase gradient parameter α, a second phase gradient parameter β, and command information. The antenna control unit 21 inputs, to the plurality of front-end circuits 23, for example, the first phase gradient parameter α, the second phase gradient parameter β, and the command information received from the external communication control device 20 or the like.

The first phase gradient parameter α and the second phase gradient parameter β are parameters related to a phase difference between the antenna elements 5 adjacent to each other. For example, in a case where the plurality of antenna elements 5 are arranged on an XY plane of an X axis, a Y axis, and a Z axis forming a three-dimensional orthogonal coordinate system, the first phase gradient parameter α is related to a phase difference in an X axis direction, and the second phase gradient parameter β is related to a phase difference in a Y axis direction. For example, as shown in the following Equation (1), the first phase gradient parameter α and the second phase gradient parameter β are described by an interval dx in the X axis direction and an interval dy in the Y axis direction of the adjacent antenna elements 5, a wavelength λ of a beam-shaped high-frequency signal emitted or received by the antenna element 5, and a first angle θ and a second angle q that define a direction of a beam-shaped high-frequency signal in a spherical coordinate system. The first angle θ is, for example, a zenith angle θ, which is an angle formed by the Z axis and the radius. The second angle φ is, for example, an azimuthal angle φ, which is an angle formed by the X axis and the projection obtained by projecting the radius onto the XY plane.

$$\begin{matrix}{α}_{E} = α \div γ X = \frac{dx \times sin θ \times cos φ \times 360}{λ} \times \frac{1}{γ X} \\ {β}_{E} = β \div γ Y = \frac{dy \times sin θ \times sin φ \times 360}{λ} \times \frac{1}{γ Y}\end{matrix} \} \qquad ( 1 )$$

The command information is, for example, a command to change the resolution of a direction (beam direction) of the beam-shaped high-frequency signal emitted or received by the antenna element 5 or information on a density parameter related to the resolution of the beam direction. The density parameter is, for example, a first density parameter γX related to the resolution in the X axis direction and a second density parameter γY related to the resolution in the Y axis direction.

The relay circuit 22 includes, for example, a switching unit 31 and a dividing/combining unit (Σ) 32.

The switching unit 31 includes, for example, two switches (SW) and two amplifiers connected in anti-parallel between the two switches (SW). The switching unit 31 switches, for example, a path of the RF signal to either one of the two amplifiers.

The dividing/combining unit (Σ) 32 functions as each of a divider that divides the high-frequency signal and a combiner that combines the high-frequency signals. The dividing/combining unit (Σ) 32 divides, for example, the RF signal output from the switching unit 31 among the plurality of front-end circuits 23. The dividing/combining unit (Σ) 32 combines, for example, the RF signals output from the plurality of front-end circuits 23 and outputs the combined RF signal to the switching unit 31.

Each of the plurality of front-end circuits 23 includes, for example, a phase shifter 33, a first switch (SW1) 34 and a second switch (SW2) 35, a transmitting-side variable gain amplifier 36a and a receiving-side variable gain amplifier 36b, a power amplifier 37a and a low-noise amplifier 37b, a parameter acquisition unit 38, and a set value acquisition unit 39.

The phase shifter 33 sets the phase of the RF signal according to, for example, a phase-shifting set value (phase shift set value) δ input from the set value acquisition unit 39 described below.

The first switch (SW1) 34 is connected to the phase shifter 33, and the second switch (SW2) 35 is connected to the antenna element 5. The first switch (SW1) 34 and the second switch (SW2) 35 switch between a transmitting-side path SR and a receiving-side path RR for the RF signal, for example, between the phase shifter 33 and the antenna element 5.

The transmitting-side variable gain amplifier 36a and the power amplifier 37a are sequentially connected in series, for example, from the first switch (SW1) 34 to the second switch (SW2) 35 in the transmitting-side path SR between the first switch (SW1) 34 and the second switch (SW2) 35. The low-noise amplifier 37b and the receiving-side variable gain amplifier 36b are sequentially connected in series, for example, from the second switch (SW2) 35 to the first switch (SW1) 34 in the receiving-side path RR between the first switch (SW1) 34 and the second switch (SW2) 35. The transmitting-side variable gain amplifier 36a and the power amplifier 37a are connected in anti-parallel with the receiving-side variable gain amplifier 36b and the low-noise amplifier 37b, for example, between the first switch (SW1) 34 and the second switch (SW2) 35.

The transmitting-side variable gain amplifier 36a and the receiving-side variable gain amplifier 36b set the intensity of the RF signal according to, for example, an intensity set value (gain set value) g input from the set value acquisition unit 39 described below.

The power amplifier 37a amplifies, by a predetermined amplification factor, for example, the RF signal flowing in the transmitting-side path SR from the transmitting-side variable gain amplifier 36a to the second switch (SW2) 35.

The low-noise amplifier 37b amplifies, by a predetermined amplification factor, for example, the RF signal flowing in the receiving-side path RR from the second switch (SW2) 35 to the receiving-side variable gain amplifier 36b.

The parameter acquisition unit 38 acquires, for example, a phase shift parameter Ψ related to the phase shift of the antenna element 5 in accordance with the first phase gradient parameter α, the second phase gradient parameter β, and the command information received from the antenna control unit 21. The parameter acquisition unit 38 calculates the phase shift parameter Ψ based on, for example, the first phase gradient parameter α and the second phase gradient parameter β, the physical position of the antenna element 5 stored in advance, and the first density parameter γX and the second density parameter γY according to the command information. The physical position of the antenna element 5 is, for example, an X coordinate and a Y coordinate in the XY plane in which the plurality of antenna elements 5 are arranged. For example, the position of the antenna element 5 corresponding to an appropriate natural number k among n antenna elements 5 (and front-end circuits 23), where n is a predetermined natural number, is an X coordinate x(k) on the X axis and a Y coordinate y(k) on the Y axis.

The parameter acquisition unit 38 changes or switches the first density parameter γX and the second density parameter γY in accordance with the command information received from the antenna control unit 21, for example. The parameter acquisition unit 38 may store in advance table data of the first density parameter γX and the second density parameter γY designated by the command information received from the antenna control unit 21, for example. The parameter acquisition unit 38 may extract information of the first density parameter γX and the second density parameter γY included in the command information received from the antenna control unit 21, for example.

The parameter acquisition unit 38 calculates a first changed phase gradient parameter α_{E} and a second changed phase gradient parameter β_{E} shown in the above Equation (1) and a changed X coordinate x_{C}(k) and a changed Y coordinate y_{C}(k) shown in the following Equation (2) by using, for example, the first density parameter γX and the second density parameter γY that are appropriately set.

$$\begin{matrix}{x}_{C} ( k ) = x ( k ) \times γ X \\ {y}_{C} ( k ) = y ( k ) \times γ Y\end{matrix} \} \qquad ( 2 )$$

The parameter acquisition unit 38 calculates a phase shift parameter Ψ(k) corresponding to an appropriate natural number k as shown in the following Equation (3), based on, for example, the first changed phase gradient parameter α_{E} and the second changed phase gradient parameter β_{E} shown in the above Equation (1) and the changed X coordinate x_{C} (k) and the changed Y coordinate y_{C} (k) shown in the above Equation (2).

$$Ψ ( k ) = x ( k ) \times α + y ( k ) \times β = {x}_{C} ( k ) \times {α}_{E} + {y}_{C} ( k ) \times {β}_{E} \qquad ( 3 )$$

The parameter acquisition unit 38 calculates the phase shift parameter Ψ(k) by, for example, the first density parameter γX and the second density parameter γY that act in a canceling manner between the first phase gradient parameter α and the second phase gradient parameter β, and the X coordinate x(k) and the Y coordinate y(k). For example, as shown in the above Equation (1), the first changed phase gradient parameter α_{E} and the second changed phase gradient parameter β_{E} are calculated by dividing the first phase gradient parameter α and the second phase gradient parameter β by the first density parameter γX and the second density parameter γY. For example, as shown in the above Equation (2), the changed X coordinate x_{C} (k) and the changed Y coordinate y_{C} (k) based on an appropriate natural number k are calculated by multiplying the X coordinate x(k) and the Y coordinate y(k) based on an appropriate natural number k by the first density parameter γX and the second density parameter γY.

Each of the first density parameter γX and the second density parameter γY is set to, for example, a value less than 1 (γX<1, γY<1), thereby increasing the resolution of the beam direction in each of the X axis direction and the Y axis direction of the beam-shaped high-frequency signal emitted or received by the antenna element 5. In this case, the changed X coordinate x_{C} (k) and the changed Y coordinate y_{C} (k) are scaled down compared to the X coordinate x(k) and the Y coordinate y(k). The first changed phase gradient parameter «E and the second changed phase gradient parameter β_{E} are scaled up compared to the first phase gradient parameter α and the second phase gradient parameter β.

Each of the first density parameter γX and the second density parameter γY is set to, for example, a value greater than 1 (γX>1, γY>1), thereby reducing the resolution of the beam direction in each of the X axis direction and the Y axis direction of the beam-shaped high-frequency signal emitted or received by the antenna element 5. In this case, the changed X coordinate x_{C}(k) and the changed Y coordinate y_{C}(k) are scaled up compared to the X coordinate x(k) and the Y coordinate y(k). The first changed phase gradient parameter α_{E} and the second changed phase gradient parameter β_{E} are scaled down compared to the first phase gradient parameter α and the second phase gradient parameter β.

The set value acquisition unit 39 acquires, for example, a phase-shifting set value (phase shift set value) δ and an intensity set value (gain set value) g according to the phase shift parameter Ψ acquired by the parameter acquisition unit 38. The set value acquisition unit 39 stores in advance, for example, table data (or map data) indicating a correspondence relationship between the phase shift parameter Ψ, and the phase-shifting set value (phase shift set value) δ and the intensity set value (gain set value) g. The set value acquisition unit 39 acquires, for example, the phase-shifting set value (phase shift set value) δ and the intensity set value (gain set value) g by referring to the table data stored in advance, according to the phase shift parameter Ψ input from the parameter acquisition unit 38. The set value acquisition unit 39 inputs the phase-shifting set value (phase shift set value) δ to the phase shifter 33 and inputs the intensity set value (gain set value) g to the transmitting-side variable gain amplifier 36a and the receiving-side variable gain amplifier 36b.

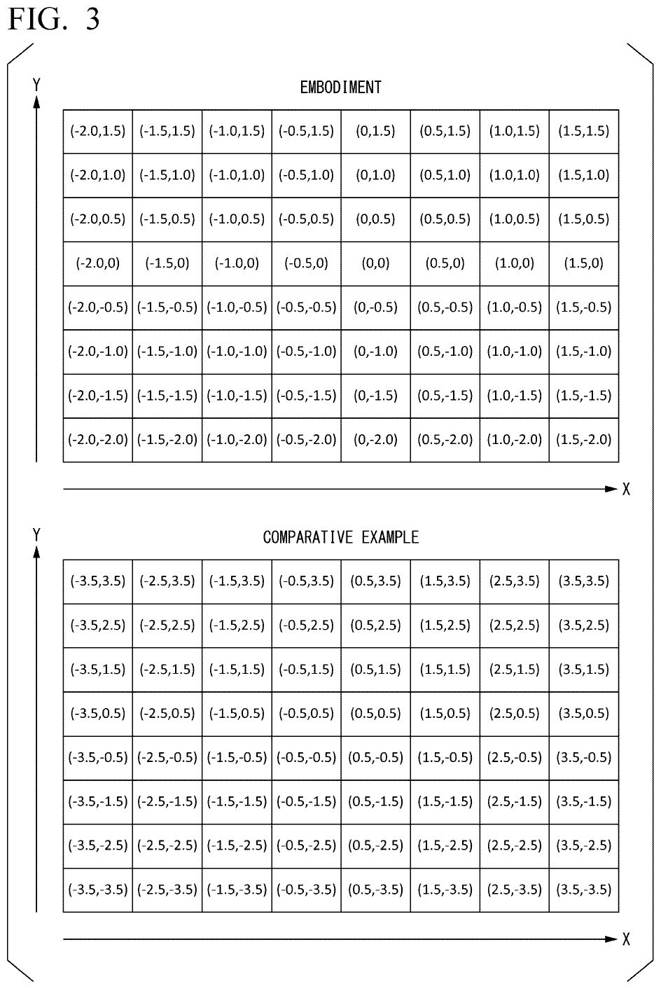

FIG. 3 is a diagram showing an example of a combination of an X coordinate and a Y coordinate of the array antenna 7 in the embodiment and a comparative example.

As shown in FIG. 3, the array antenna 7 of each of the embodiment and the comparative example includes, for example, a total of 64 antenna elements 5 arranged in 8 rows in each of the X axis direction and the Y axis direction. A combination of the X coordinate and the Y coordinate of each antenna element 5 of the embodiment is a position (x_{C}(k), y_{C}(k)) based on the changed X coordinate x_{C}(k) and the changed Y coordinate y_{C}(k). A combination of the X coordinate and the Y coordinate of each antenna element 5 of the comparative example is a position (x(k), y(k)) based on the X coordinate x(k) and the Y coordinate y(k). Each of the first density parameter γX and the second density parameter γY of the embodiment is, for example, 0.5 (γX=γY=0.5). The changed X coordinate x_{C}(k) and the changed Y coordinate y_{C}(k) of the embodiment are scaled down to ½ compared to the X coordinate x(k) and the Y coordinate y(k) of the comparative example.

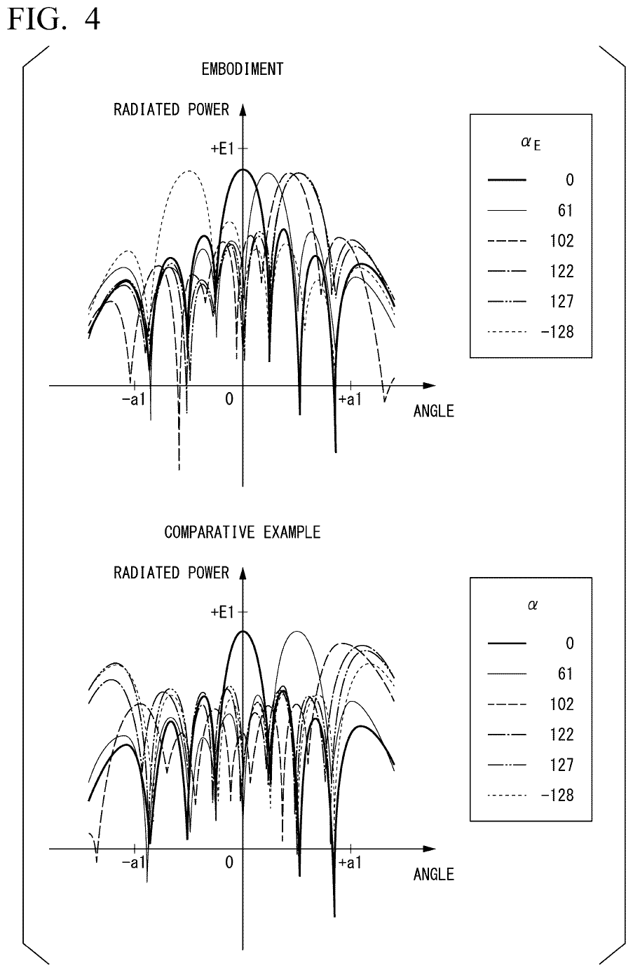

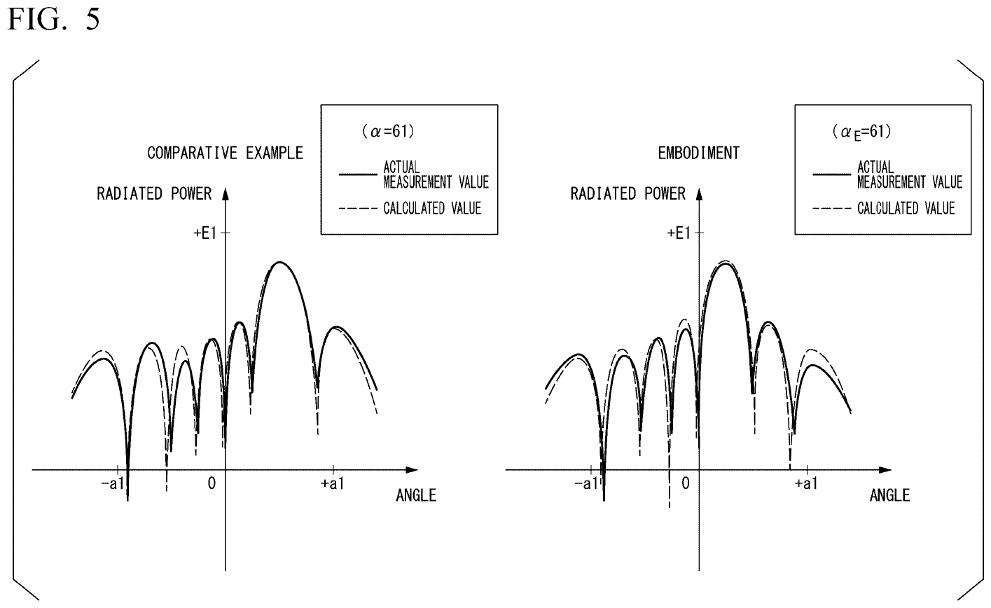

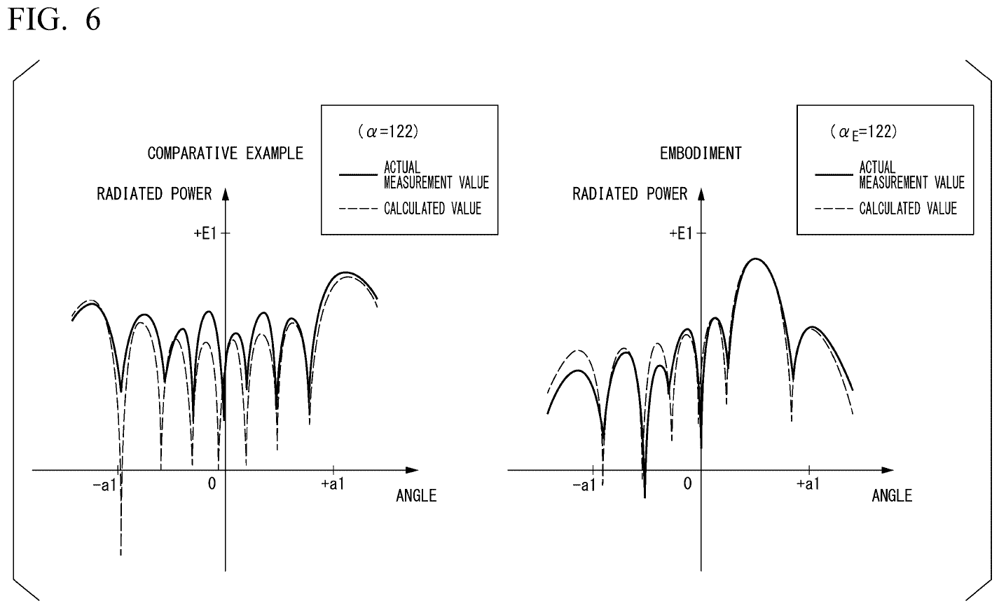

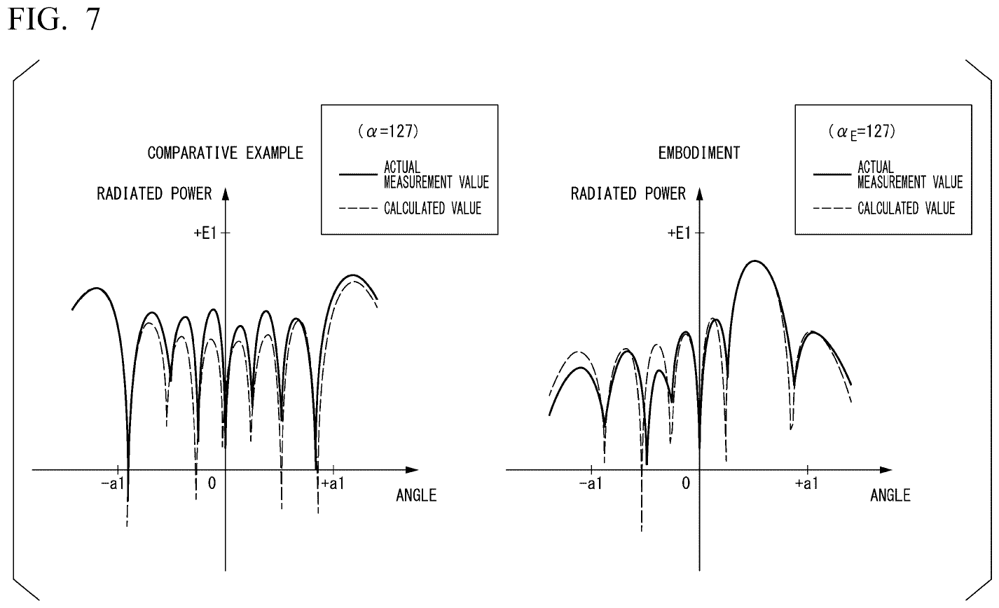

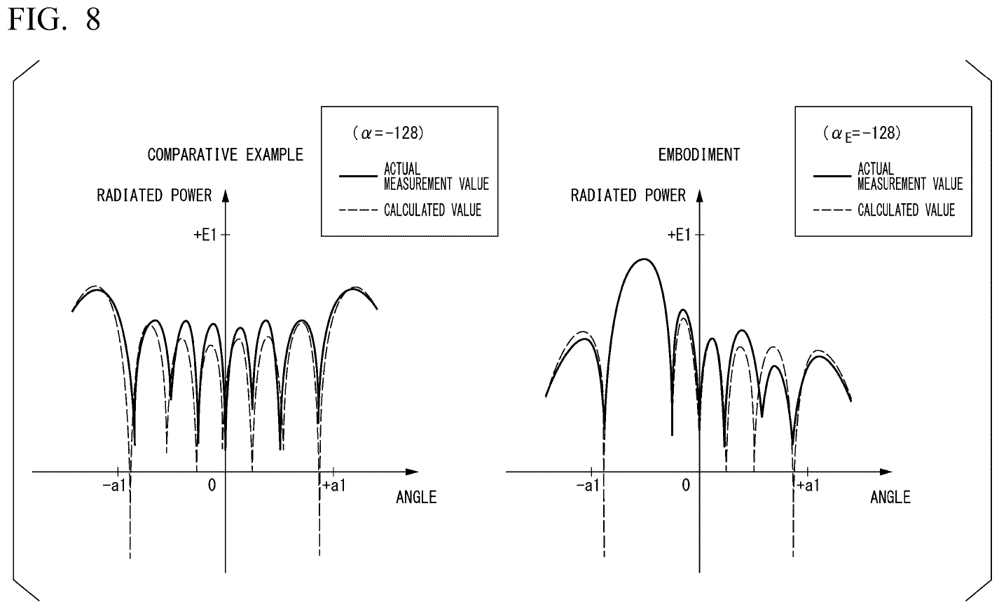

FIGS. 4, 5, 6, 7, and 8 are diagrams showing an example of a change in radiated power according to an angle of the array antenna 7 in the embodiment and the comparative example. The angle of the array antenna 7 is, for example, a first angle θ (zenith angle θ). A horizontal axis corresponds to the first angle θ, and a second angle φ is zero (φ=0°). A direction corresponding to zero (θ=0°) of the first angle θ is a front direction of the array antenna 7, and is a direction orthogonal to the X axis and the Y axis in FIGS. 4 to 8, that is, a front direction on the drawings. A direction corresponding to the first angle θ=90° and the second angle φ=0° is the same as the X axis in FIGS. 4 to 8. The first phase gradient parameter α and the first changed phase gradient parameter α_{E} are set to, for example, values of 0, 61, 102, 122, 127, and −128. When the second angle φ is zero, the second phase gradient parameter β and the second changed phase gradient parameter β_{E} are zero. The radiated power is, for example, an equivalent isotropically radiated power (EIRP) or an effective isotropically radiated power (EIRP). FIG. 4 shows an actual measurement value of the radiated power, and FIGS. 5, 6, 7, and 8 show an actual measurement value and a calculated value of the radiated power. Each of the first density parameter γX and the second density parameter γY of the embodiment is 0.5 (γX=γY=0.5).

As shown in FIGS. 4, 5, 6, 7, and 8, in the embodiment, the unimodality with a single peak of the radiated power is recognized for each value of the first changed phase gradient parameter α_{E}. For example, in a case where the first phase gradient parameter α in the comparative example is each of values of 122, 127, and −128, the unimodality of the radiated power is not recognized, whereas, in a case where the first changed phase gradient parameter α_{E} in the embodiment is each of values of 122, 127, and −128, the unimodality of the radiated power is recognized.

When the first density parameter γX and the second density parameter γY of the embodiment are each 0.5 (γX=γY=0.5), it is recognized that the same radiated power pattern is obtained in a case where the first phase gradient parameter α in the comparative example is 61 and in a case where the first changed phase gradient parameter α_{E} of the embodiment is 122.

As described above, according to the high-frequency circuit 3 and the antenna module 1 of the embodiment, the resolution of the beam direction of the beam-shaped high-frequency signal (beam) emitted or received by each of the plurality of antenna elements 5 can be easily controlled by using each of the density parameters γX and γY. It is possible to reduce the number of invalid combinations of the first changed phase gradient parameter α_{E} and the second changed phase gradient parameter β_{E}, and to increase the number of beam patterns to be practically used.

For example, it is possible to change the resolution of the beam direction regardless of the radio frequency of a carrier wave, the arrangement state of the antenna element 5, and the like. By increasing the resolution of the beam direction, it is possible to easily suppress deviations in a beam arrival position in long-distance communication or the like. Even in a case where the resolution of the beam direction fluctuates according to a change in the radio frequency of the carrier wave, it is possible to perform appropriate measures such as cancellation by using each of the density parameters γX and γY.

Since the density parameters γX and γY act in a canceling manner between the phase gradient parameters α and β, and the coordinate x(k) and y(k), the phase shift parameter Ψ(k) can be acquired based on the changed phase gradient parameters α_{E} and β_{E}, and the changed X coordinate x_{C}(k) and the changed Y coordinate y_{C}(k) through the same processing as in a case where the density parameters γX and γY are not used.

When the changed X coordinate x_{C}(k) and the changed Y coordinate y_{C}(k) are calculated using, for example, the density parameters γX and γY according to the command information received from the antenna control unit 21, it is possible to flexibly respond to the changes in the density parameters γX and γY while suppressing an increase in the amount of data stored in advance.

### Modification Example

Hereinafter, a modification example of the embodiment will be described. In addition, the same parts as those in the above-described embodiment are denoted by the same reference numerals, and the description thereof will be omitted or simplified.

In the above-described embodiment, the parameter acquisition unit 38 may acquire the phase shift parameter Ψ(k) based on the density parameters γX and γY independently set for the phase gradient parameters α and β. For example, the degree of freedom in controlling the beam pattern (antenna directivity) can be improved by using the respective density parameters γX and γY different from each other without being restricted by the arrangement state and the like of the plurality of antenna elements 5.

For example, in a case where the array antenna 7 includes a total of 256 antenna elements 5 arranged in 8 rows in the X axis direction and 32 rows in the Y axis direction, and the intervals dx and dy in the X axis direction and the Y axis direction are the same, the outer shape of the array antenna 7 has a longer shape in the Y axis direction than in the X axis direction. In this case, in a case where the outputs of all the antenna elements 5 are the same, a high-frequency signal (beam) having a narrower beam width in the Y axis direction than in the X axis direction is obtained. Therefore, in a case where the beam direction cannot be directed with finer resolution in the Y axis direction, a region on which the beam cannot be radiated is likely to occur. In order to solve such a problem, for example, by setting the first density parameter γX to be greater than 1 (γX>1) and setting the second density parameter γY to be less than 1 (γY<1), the resolution of the beam direction can be decreased in the X axis direction and be increased in the Y axis direction. By decreasing the number of stages in which the beam direction can be directed in the X axis direction and increasing the number of stages in the Y axis direction, it is possible to suppress an increase in the amount of data for each of the changed phase gradient parameters α_{E} and β_{E} required for control.

In the above-described embodiment, the parameter acquisition unit 38 calculates the changed X coordinate x_{C}(k) and the changed Y coordinate y_{C}(k) using the first density parameter γX and the second density parameter γY according to the command information received from the antenna control unit 21, but the present disclosure is not limited to this. For example, the parameter acquisition unit 38 may store, in advance, data of the changed X coordinate x_{C}(k) and the changed Y coordinate y_{C}(k). For example, the term “in advance” refers to a timing before a command for beam switching is received. For example, the data of the changed X coordinate x_{C}(k) and the changed Y coordinate y_{C}(k) may be stored at the shipment from the factory, may be received from an external source as initial set values immediately after every startup of the beam former IC (BFIC) 14, or may be updated periodically during the operation of the beam former integrated circuit (BFIC) 14.

Accordingly, it is possible to suppress an increase in a load required for the acquisition processing of the phase shift parameter Ψ(k). It is possible to improve the degree of freedom in controlling the beam pattern (antenna directivity) while suppressing a decrease in processing speed or an increase in the scale of the configuration required for the processing.

For example, by changing the changed X coordinate x_{C}(k) and the changed Y coordinate y_{C}(k) in accordance with the change of the respective density parameters γX and γY according to the radio frequency of the carrier wave, the same beam direction can be obtained even in a case where the radio frequency is changed without changing the respective changed phase gradient parameters α_{E} and β_{E}.

For example, by changing the changed X coordinate x_{C}(k) and the changed Y coordinate y_{C}(k), it is possible to cancel the variations in the interval between the changeable beam directions that occur when the radio frequency changes. Accordingly, for example, in a case where different radio frequencies are used for transmission and reception, it is possible to eliminate the need to adjust the respective changed phase gradient parameters α_{E} and β_{E}. For example, when a signal of 26 GHz is input to the array antenna 7 designed to be optimized for communication at 28 GHz, the density of the beam that can be emitted becomes coarse. In this case, by setting each of the density parameters γX and γY to be less than 1 (γX<1, γY<1), it is possible to obtain the same beam direction as in the case of 28 GHz. Meanwhile, for example, when a signal of 30 GHz is input to the array antenna 7 designed to be optimized for communication at 28 GHz, the density of the beam that can be emitted becomes finer. In this case, by setting each of the density parameters γX and γY to be greater than 1 (γX>1, γY>1), it is possible to obtain the same beam direction as in the case of 28 GHz.

For example, by changing the changed X coordinate x_{C}(k) and the changed Y coordinate y_{C}(k) as needed, the beam can be directed on a wide range with coarse beam direction switching, for example, when a base station searches for a mobile object in communication between the mobile object and the base station. On the other hand, in a case of high-speed communication between the searched mobile object and the base station, communication can be performed with fine beam direction switching.

In the above-described embodiment, the parameter acquisition unit 38 calculates the changed phase gradient parameters α_{E} and β_{E} using the first phase gradient parameter α and the second phase gradient parameter β received from the antenna control unit 21 and the first density parameter γX and the second density parameter γY according to the command information, but the present disclosure is not limited to this. For example, the parameter acquisition unit 38 may receive the changed phase gradient parameters α_{E} and β_{E} from the antenna control unit 21 instead of the phase gradient parameters α and β. In this case, the parameter acquisition unit 38 may calculate the changed X coordinate x_{C}(k) and the changed Y coordinate y_{C}(k) using the table data of the density parameters γX and γY designated by the command information or the density parameters γX and γY extracted from the command information, as in the above-described embodiment. In addition, the parameter acquisition unit 38 may store in advance the data of the changed X coordinate x_{C}(k) and the changed Y coordinate y_{C}(k), as in the above-described modification example. The data of the changed X coordinate x_{C}(k) and the changed Y coordinate y_{C}(k) may be, for example, individual data set for each combination of the parameter acquisition unit 38 and the antenna element 5, or may be table data corresponding to a plurality of combinations of the parameter acquisition unit 38 and the antenna element 5. For example, in the case of table data, each parameter acquisition unit 38 may receive, from the antenna control unit 21, information for designating a specific combination of the parameter acquisition unit 38 and the antenna element 5.

In the above-described embodiment, the parameter acquisition unit 38 may represent each of the changed phase gradient parameters α_{E} and β_{E} in a two's complement fixed-point format.

In the above-described embodiment, the parameter acquisition unit 38 may represent the changed X coordinate x_{C}(k) and the changed Y coordinate y_{C}(k) in a two's complement fixed-point format.

For example, Table 1 below shows an example in which changes in a phase shift parameter Ψ(1) and a phase-shifting set value (phase shift set value) δ are shown in decimal numbers in response to a change in each of the changed phase gradient parameters α_{E} and β_{E} when a changed X coordinate x_{C}(1)=0.5 and a changed Y coordinate y_{C} (1)=1.25 in decimal numbers.

Each of the changed phase gradient parameters α_{E} and β_{E}, and the changed X coordinate x_{C} (1) and the changed Y coordinate y_{C} (1) are represented in binary, for example, with a 4-bit integer part and a 2-bit fractional part. Accordingly, the correspondence between the binary and decimal numbers is, for example, 0000.00 (binary)=0.0 (decimal) and 1111.11 (binary)=−0.25 (decimal). The maximum value is 0111.11 (binary)=7.75 (decimal), and the minimum value is 1000.00 (binary)=−8.00 (decimal). In a case where each of the changed phase gradient parameters α_{E} and β_{E}, and the changed X coordinate x_{C}(k) and the changed Y coordinate y_{C}(k) are represented in a fixed-point format, the information on the decimal point position can be unified in the design, and, for example, in the communication between the communication control device 20 and the antenna control unit 21, the information on the decimal point may be omitted, and 1111.11 (binary) may be transmitted as 111111 (binary).

TABLE 1

| α_{E} | x_{C}(1) × α_{E} | β_{E} | y_{C}(1) × β_{E} | Ψ(1) | δ |
|---|---|---|---|---|---|
| 1.0 | 0.5 | 0.0 | 0.0 | 0.5 | 11.25° |
| 1.5 | 0.75 | 1.0 | 1.25 | 2.0 | 45.0° |
| 2.0 | 1.0 | 2.0 | 2.5 | 3.5 | 78.75° |
| 2.5 | 1.25 | 3.0 | 3.75 | 5.0 | 112.5° |
| 3.0 | 1.5 | 4.0 | 5.0 | 6.5 | 146.25° |
| 7.75 | 3.75 | 7.75 | 9.75 | 13.5 | −56.25° |
| −8.0 | −4.0 | −8.0 | −10 | −14 | 45.0° |

In Table 1, for example, the phase shift parameter Ψ(1), 0000.00 (binary)=0.0 (decimal), corresponds to the phase-shifting set value (phase shift set value) δ of 0.0°, and the phase shift parameter Ψ(k), 1111.11 (binary)=−0.25 (decimal), corresponds to the phase-shifting set value (phase shift set value) δ of approximately 5.6°. The maximum value of the phase shift parameter Ψ(1), 0111.11 (binary)=7.75 (decimal), corresponds to the phase-shifting set value (phase shift set value) δ of approximately 174.4°, and the minimum value of the phase shift parameter Ψ(1), 1000.00 (binary)=−8.00 (decimal), corresponds to the phase-shifting set value (phase shift set value) δ of −180.0°.

For example, when an overflow occurs, such as when the phase shift parameter Ψ(1)=111000.00 (binary), the parameter acquisition unit 38 discards the excess higher-order bits to set the phase shift parameter Ψ(1)=1000.00 (binary). As a result, the phase-shifting set value (phase shift set value) δ becomes −180.0°.

The phase-shifting set value (phase shift set value) δ is in a range of −180° to +180°, and for example, +370° is equivalent to +10°. Since the excess higher-order bits can be discarded even during intermediate calculations, for example, the phase-shifting set value (phase shift set value) δ is +45°=+405°=+1845°=−315°.

In Table 1, the overflow is not discarded in the intermediate calculations. However, for example, by discarding the overflow in y_{C} (1)×β_{E}=−10 (decimal)=10110.00 (binary), even in a case where y_{C} (1)×β_{E}=0110.00 (binary), the phase shift parameter Ψ(1)=−4.0+6.0=+2.0, and the phase-shifting set value (phase shift set value) δ=45.0°.

In Table 1, the product of α_{E}=7.75 (decimal) and x_{C} (1)=0.5 (decimal) is 3.75 (decimal), that is obtained by truncating the third and fourth fractional bits in binary. The product without truncation is 3.875 (decimal). The fractional-bit truncation may be freely set by a designer or the like as appropriate such that the desired accuracy required by the set value acquisition unit 39 can be ensured, for example.

As described above, by representing each of the changed phase gradient parameters α_{E} and β_{E}, and the changed X coordinate x_{C}(k) and the changed Y coordinate y_{C}(k) in a two's complement fixed-point format that, for example, includes values with zero fractional digits, it is possible to suppress an increase in circuit size and the number of calculation processing steps. It is possible to decrease the time required for switching the beam pattern while suppressing an increase in cost required for the circuit configuration.

In addition, in the above-described embodiment, the plurality of parameter acquisition units 38 may execute the acquisition of the phase shift parameter Y′ (k) in parallel. It is possible to decrease the time required for switching the beam pattern by the parallel processing.

In the above-described embodiment, the set value acquisition unit 39 acquires the phase-shifting set value (phase shift set value) δ and the intensity set value (gain set value) g according to the phase shift parameter Y, but the present disclosure is not limited to this. For example, the set value acquisition unit 39 may acquire only the phase-shifting set value (phase shift set value) δ according to the phase shift parameter Ψ.

The embodiments of the present disclosure are shown as examples, and it should be understood that these do not limit the scope of the disclosure. These embodiments may be embodied in a variety of other forms, and various omissions, substitutions, and modifications may be made within the scope of the disclosure.

These embodiments and modifications thereof are included in the scope of the inventions and their equivalents as defined in the accompanying claims, as well as within the scope of the disclosure.

What is claimed is:

1. A high-frequency circuit comprising:
a parameter acquisition unit configured to acquire a phase shift parameter related to phase shift of each of a plurality of antenna elements based on at least one phase gradient parameter related to a phase difference between the antenna elements adjacent to each other, the phase gradient parameter being set corresponding to a beam direction of a beam-shaped high-frequency signal to be transmitted and received by each of the plurality of antenna elements, a physical position of each of the plurality of antenna elements, and a density parameter related to resolution of the beam direction; and
a set value acquisition unit configured to acquire a set value of the phase shift of each of the antenna elements according to the phase shift parameter.

2. The high-frequency circuit according to claim 1,
wherein the parameter acquisition unit is configured to acquire the phase shift parameter based on at least one changed phase gradient parameter and a changed position obtained by the density parameter that acts in a canceling manner between the phase gradient parameter and the position.

3. The high-frequency circuit according to claim 2,
wherein the parameter acquisition unit is configured to store, in advance, data of the changed position according to the density parameter.

4. The high-frequency circuit according to claim 2,
wherein the parameter acquisition unit is configured to calculate the changed position based on the density parameter externally acquired and the position stored in advance.

5. The high-frequency circuit according to claim 1,
wherein the parameter acquisition unit is configured to acquire the phase shift parameter based on a plurality of the density parameters independently set for a plurality of the phase gradient parameters.

6. The high-frequency circuit according to claim 1,
wherein the set value acquisition unit is configured to acquire the set value of the phase shift of each of the antenna elements and a set value of intensity of each of the antenna elements according to the phase shift parameter.

7. The high-frequency circuit according to claim 1,
wherein the parameter acquisition unit is configured to represent a changed phase gradient parameter obtained by the phase gradient parameter and the density parameter in a two's complement fixed-point format.

8. The high-frequency circuit according to claim 1,
wherein the parameter acquisition unit is configured to represent a changed position obtained by the position and the density parameter in a two's complement fixed-point format.

9. The high-frequency circuit according to claim 1,
wherein the parameter acquisition unit is configured to execute acquisition of the phase shift parameter in parallel.

10. An antenna module comprising:
the high-frequency circuit according to claim 1; and
a plurality of antenna elements electrically connected to the high-frequency circuit.
